(19) United States
(12) Patent Application Publication
(10) Pub. No.: US 2021/0060604 A1
(43) Pub. Date: Mar. 4, 2021

(54) PROCESS AND DEVICE FOR LARGE-SCALE NONCOVALENT FUNCTIONALIZATION OF NANOMETER-SCALE 2D MATERIALS USING HEATED ROLLER LANGMUIR-SCHAEFER CONVERSION

(71) Applicant: Purdue Research Foundation, West Lafayette, IN (US)

(72) Inventors: Shelley A. Claridge, Lafayette, IN (US); Tyler Robert Hayes, Lafayette, IN (US); James Robert Zimmerman, Oxford, IN (US)

(73) Assignee: Purdue Research Foundation, West Lafayette, IN (US)

(21) Appl. No.: 17/004,082

(22) Filed: Aug. 27, 2020

Related U.S. Application Data
(60) Provisional application No. 62/893,514, filed on Aug. 29, 2019.

(51) Int. Cl. B05D 1/20; C01B 32/194; C01B 32/21; C01G 39/06; C01G 41/00; C08F 38/00; C09D 149/00; B05D 3/06; B22F 1/00; B22F 9/24

(52) U.S. Cl. CPC B05D 1/206; C01B 32/194; C01B 32/21; C01G 39/06; C01G 41/00; B22F 2301/255; C09D 149/00; B05D 3/067; B22F 1/0025; B22F 9/24; C08F 38/00

(57) ABSTRACT

The present invention generally relates to a device and a process for performing large-scale noncovalent functionalization of 2D materials, with chemical pattern elements as small as a few nanometers, using thermally controlled rotary Langmuir-Schaefer conversion. In particular, the present invention discloses a device comprising a thermally regulated disc driven by a rotor with fine speed control configured to be operable with a Langmuir trough for performing large-scale noncovalent functionalization of 2D materials, achieving ordered domain areas up to nearly 10,000 μm², with chemical pattern elements as small as a few nanometers. A process using the device for performing large-scale noncovalent functionalization of 2D materials with chemical pattern elements as small as a few nanometers is within the scope of this disclosure. The process we demonstrate would be readily extensible to roll-to-roll processing, addressing a longstanding challenge in scaling Langmuir-Schaefer transfer for practical applications.

### CROSS REFERENCE TO RELATED APPLICATION

This present patent application relates to and claims the priority under 35 U.S.C. § 119(e) to U.S. Provisional Patent Application Ser. No. 62/893,514 filed on Aug. 29, 2019, the content of which is hereby incorporated by reference in its entirety into the present disclosure.

### GOVERNMENT SUPPORT CLAUSE

This invention was made with government support under grant CHE1555173 awarded by the National Science Foundation. The government has certain rights in the invention.

### TECHNICAL FIELD

The present invention generally relates to a device and a process for large-scale noncovalent functionalization of 2D materials, to produce nanometer-scale features, using thermally controlled rotary Langmuir-Schaefer conversion. In particular, the present invention discloses a device comprising a thermally regulated disc driven by a rotor with fine speed control configured to be operable with a Langmuir trough for generating large-scale noncovalent functionalization of 2D materials to provide nanometer-scale features. A process using the device for generating large-scale noncovalent functionalization of 2D materials, to provide nanometer-scale features, is within the scope of this disclosure.

### BACKGROUND

This section introduces aspects that may help facilitate a better understanding of the disclosure. Accordingly, these statements are to be read in this light and are not to be understood as admissions about what is or is not prior art.

Integrating graphene with into functional hybrids materials and devices increasingly requires the capability to structure and template interactions with the environment across a range of length scales (Mann, J. A., et al., J. Phys. Chem. Lett 2013, 4, 2649-2657; MacLeod, J. M., et al., Small 2014, 10, 1038-1049; Bang, J. J., et al., J. Am. Chem. Soc. 2016, 138, 4448-4457). Noncovalent ligand chemistries are frequently desirable in functionalizing 2D materials because they do not disrupt electronic conjugation within the basal plane; however, this raises the challenge of stabilizing the monolayer toward solvents exposure and other common processing conditions.

Noncovalent monolayer chemistries are widely used in controlling surface chemistry of layered materials. Integrating functionalized 2D materials into multilayer device architectures suggests the need for functionalization strategies that are not only robust toward solution or vacuum processing, but also enables spatially controlled interactions with other materials in a hybrid. Synergistic with this need, lying down phases of functional alkanes commonly used in noncovalent functionalization present 1-nm-wide rows of paired functional headgroups separated by ˜5 nm stripes of exposed alkane chains.

Advances in nanoscale electronics,¹⁻² photovoltaics³⁻⁴ and biosensors⁵⁻⁶ incorporating 2D hybrid materials have elevated the demand for scalable processes that can control the surface chemistry of 2D materials such as graphene,⁷⁻⁸ highly oriented pyrolytic graphite (HOPG),⁹⁻¹¹ transition metal dichalcogenides (e.g., MoS₂, WS₂),¹²⁻¹⁴ and black phosphorous^{13,15} over large areas. In order to preserve the extended electronic delocalization networks intrinsic to the basal plane of 2D materials, noncovalent functionalization with organic molecules^{7,14-19} or inorganic nanoparticles²⁰⁻²¹ is often leveraged to modulate 2D material physical properties. Molecules with long alkyl chains or polycyclic aromatic groups are commonly used due to strong epitaxial ordering into lying-down phases on 2D material surfaces.⁷⁻⁸

Noncovalent functionalization of 2D materials can be achieved via several methods, including drop-casting from organic solvents,²²⁻²⁴ flow-induced wicking,²⁵⁻²⁶ solution-shearing,²⁷ and deposition from Langmuir films.^{9,28-30} While drop-casting from organic solvent is experimentally expedient for assembly over small areas, significant challenges arise in controlling solvent drying and other processes that can lead to heterogeneity in assembled structures over larger areas. Modified drop-casting methods (e.g. flow-induced wicking, solution-shearing) that control solvent flow near the substrate can promote long-range ordering for molecules such as polyaromatic hydrocarbons on HOPG.²⁵⁻²⁷ However, for many other classes of important functional molecules, such as long-chain amphiphiles, substantial challenges arise in generating long-range molecular ordering, or ordering over large areas of 2D substrates, using solution processing techniques. Langmuir transfer techniques can enable long-range ordering of amphiphilic molecules on solid substrates through the preordering of molecular films on an aqueous subphase prior to transfer.³⁰⁻³² Langmuir-Blodgett, LB, transfer (substrate is oriented perpendicular to the Langmuir film, and drawn vertically through it)³³⁻³⁵ and Langmuir-Schaefer, LS, transfer (substrate is oriented parallel to the Langmuir film, and lowered into contact, then withdrawn)³⁶ have both been broadly utilized for ordering and patterning of standing phase molecular films.^{30,31,35} LS transfer has also been shown by our group^{9-10,12,37} and others^{29,38-40} to be useful in functionalizing 2D materials through the conversion of standing phase Langmuir films to ordered lying-down phases on 2D substrates, a process we refer to as LS conversion.

Most classical approaches to both LB and LS transfer seek to strictly maintain the initial molecular ordering in the Langmuir film by transferring segments of the standing phase film directly to the receiving substrate. However, for LS conversion, the film undergoes a fundamental reordering, from standing phase at the air-water interface to lying-down phase on the receiving substrate (FIG. 1A). This difference creates new opportunities to manipulate the transfer process to generate long-range order, and to increase functionalized surface area. Recently, we developed a heated transfer stage to control substrate temperature during LS conversion.³² Thermally controlled transfer (setpoints ca. 60-80° C.) enabled assembly of noncovalent molecular domains of diyne phospholipids with edge lengths at least an order of magnitude larger than those assembled through room temperature LS conversion, with full coverage transfer in as little as 1 min. Monolayers transferred in this way exhibited increased robustness toward subsequent solution processing in solvents with a range of polarities, in comparison with those transferred at room temperature.³²

A longstanding barrier to the broad use of Langmuir transfer methods has been limited throughput, due to the serial nature of transfer and limit on practical trough sizes.⁴¹ Drawing inspiration from roll-to-roll processing techniques used industrially, a few accounts have recently reported LB transfer of nanoparticles from an air-liquid interface across large substrate films.⁴²⁻⁴⁴

### BRIEF DESCRIPTION OF THE DRAWINGS

Embodiments of the present disclosure will now be described by way of example in greater detail with reference to the attached Figures, in which:

FIG. 1A is an illustration of thermally controlled rotary Langmuir-Schaefer conversion to create nm-resolution chemical patterns exhibiting long-range order. FIG. 1B illustrates sequential rotary transfer to utilize nm-resolution surface templates for further surface functionalization (here, assembly of gold nanowires (AuNWs)).

FIGS. 2A-2B are schematics of the heated copper disk with a film of HOPG mounted during transfer. FIG. 2C shows an image of the thermally controlled rotary transfer stage positioned over the trough, illustrating single-barrier compression geometry. FIG. 2D shows detail of the HOPG-subphase contact meniscus.

FIGS. 3A-3B are molecular models of diyne PE lamellar phases assembled on HOPG (3A) prior to and (3B) following photopolymerization. FIG. 3C shows an AFM image illustrating lamellar periodicity of an unpolymerized diyne PE film. FIG. 3D shows a larger scale AFM image (phase), illustrating unpolymerized lamellar phase domains oriented epitaxially with the hexagonal HOPG lattice.

FIGS. 4A-4C show SEM images illustrating quantification of surface coverage for diyne PE on HOPG. FIGS. 4B and 4C are enlargements of areas in FIG. 4A highlighted with white boxes. FIG. 4B shows a subset of an area in FIG. 4A exhibiting long range molecular alignment. In FIG. 4C, red masking highlights vacancies used to calculate surface coverage for images at the scale shown in FIG. 4A. FIG. 4D shows an illustration of the five test zones along the flexible HOPG substrate film (red dashed boxes). FIG. 4E shows quantification of surface coverage along HOPG films for the three tested stage translation rates (0.14 mm/s (blue), 0.54 mm/s (red) and 1.10 mm/s (gold)

FIGS. 5A-5C show the histograms of quantified molecular domain sizes for HOPG translation rates of: (FIG. 5A) 0.14 mm/s, (FIG. 5B) 0.54 mm/s, and (FIG. 5C) 1.10 mm/s. Each set of measurements is presented as counts (blue bars), and as % measured area occupied by domains of that size (gold bars).

FIG. 6A shows median domain sizes tabulated for stage translation rates of 0.14 mm/s (blue), 0.54 mm/s (red), and 1.10 mm/s (gold). FIG. 6B shows maximum domain sizes tabulated for stage translation rates of 0.14 mm/s (blue), 0.54 mm/s (red), and 1.10 mm/s (gold). Median domain sizes along film are reported with calculated median absolute deviations.

FIG. 7A shows a schematic illustrating sequential transfer of AuNWs to a striped template. FIG. 7B shows a TEM image of ultranarrow AuNWs. FIG. 7C shows an AFM image of assembly of AuNWs on striped phase diyne PE. FIG. 7D shows an illustration of a diyne PE SAM noncovalently adsorbed atop HOPG. FIG. 7E shows an illustration of AuNW alignment on diyne PE/H₂O/oleylamine stripes. FIG. 7F-7G show SEM images of AuNWs assembled on striped phase diyne PE templates through sequential rotary transfer at room temperature. In FIG. 7F, as a guide to the eye, the border of a large unidirectional diyne PE domain is highlighted in red; small inclusion domains with different lamellar axes are highlighted in green. FIG. 7G shows a higher magnification SEM image highlighting AuNW alignment along diyne PE lamellar axes (green and red).

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

In the present disclosure the term “about” can allow for a degree of variability in a value or range, for example, within 20%, within 10%, within 5%, or within 1% of a stated value or of a stated limit of a range.

In the present disclosure the term “substantial” or “substantially” can allow for a degree of variability in a value or range, for example, within 80%, within 90%, within 95%, or within 99% of a stated value or of a stated limit of a range.

In this document, the terms “a,” “an,” or “the” are used to include one or more than one unless the context clearly dictates otherwise. The term “or” is used to refer to a nonexclusive “or” unless otherwise indicated. In addition, it is to be understood that the phraseology or terminology employed herein, and not otherwise defined, is for the purpose of description only and not of limitation. Any use of section headings is intended to aid reading of the document and is not to be interpreted as limiting. Further, information that is relevant to a section heading may occur within or outside of that particular section. Furthermore, all publications, patents, and patent documents referred to in this document are incorporated by reference herein in their entirety, as though individually incorporated by reference. In the event of inconsistent usages between this document and those documents so incorporated by reference, the usage in the incorporated references should be considered supplementary to that of this document; for irreconcilable inconsistencies, the usage in this document controls.

As used herein, an “amphiphile” is defined as a chemical compound comprising both hydrophilic and hydrophobic constituents.

As used herein, a “thin film” is defined as a layer of material ranging from less than 1 nm to several thousand nanometers in thickness. As used herein, a “large” area means an area related to an area of nano meter scale.

As used herein, a layered, or two-dimensional (2D) material generally has a layer thickness between one atomic layer and a few nm. Even though the existence of two-dimensional materials have been theorized since the 1940's (Wallace, P. R. Phys. Rev. 1947, 71, 622-634), it was not until 2004 that it was shown that these materials can be stable as freestanding sheets, by the isolation of individual graphene sheets (Novoselov, K. S. et al., Science 2004, 306, 666-669). Layers may be stacked to form macroscopic materials; for instance, highly oriented pyrolytic graphite (HOPG) consists of stacks of graphene layers.

The present invention generally relates to a device and a process for performing large-scale noncovalent functionalization of 2D materials, with chemical pattern elements as small as a few nanometers, using thermally controlled rotary Langmuir-Schaefer conversion. In particular, the present invention discloses a device comprising a thermally regulated disc driven by a rotor with fine speed control configured to be operable with a Langmuir trough for performing large-scale noncovalent functionalization of 2D materials, achieving ordered domain areas up to nearly 10,000 μm2, with chemical pattern elements as small as a few nanometers. A process using the device for performing large-scale noncovalent functionalization of 2D materials with chemical pattern elements as small as a few nanometers is within the scope of this disclosure. The process we demonstrate would be readily extensible to roll-to-roll processing, addressing a longstanding challenge in scaling Langmuir-Schaefer transfer for practical applications.

In some illustrative embodiments, this present disclosure relates to an apparatus for performing noncovalent functionalization of a 2D material substrate using Langmuir-Schaefer (LS) conversion comprising
a. a motor configured to turn a roller equipped with a thermal regulation mechanism;
b. a Langmuir trough for preparing a molecular monolayer or thin film comprising functional amphiphiles; and
c. said roller comprising a disk mounted on a translator that brings the disk in contact with said functional monolayer or thin film, and to the periphery of said disk is mounted a 2D material substrate.

In some illustrative embodiments, this present disclosure relates to an apparatus for performing noncovalent functionalization of a 2D material substrate using Langmuir-Schaefer (LS) conversion as disclosed herein, wherein said motor is a stepper motor fit for fine speed control of said roller's rotation while the disk is in contact with the functional monolayer or thin film during transferring process.

In some illustrative embodiments, this present disclosure relates to an apparatus for performing noncovalent functionalization of a 2D material substrate using Langmuir-Schaefer (LS) conversion as disclosed herein, wherein said 2D material substrate comprises graphene, highly oriented pyrolytic graphite (HOPG), or a layered material, such as a layered material of MoS₂ or WS₂.

In some illustrative embodiments, this present disclosure relates to an apparatus for performing noncovalent functionalization of a 2D material substrate using Langmuir-Schaefer (LS) conversion as disclosed herein, wherein said 2D material substrate is mounted to the disk through an adhesive.

In some illustrative embodiments, this present disclosure relates to an apparatus for performing noncovalent functionalization of a 2D material substrate using Langmuir-Schaefer (LS) conversion as disclosed herein, wherein said adhesive is stable toward use at an elevated temperature.

In some illustrative embodiments, this present disclosure relates to an apparatus for performing noncovalent functionalization of a 2D material substrate using Langmuir-Schaefer (LS) conversion as disclosed herein, wherein said apparatus is configured for continuous roll-to-roll operation.

In some illustrative embodiments, this present disclosure relates to an apparatus for performing noncovalent functionalization of a 2D material substrate using Langmuir-Schaefer (LS) conversion as disclosed herein, wherein said molecular monolayer or thin film is capable of being transferred to create a surface conferring controllable wetting characteristics or chemical functional patterns on the 2D material substrate.

In some illustrative embodiments, this present disclosure relates to an apparatus for performing noncovalent functionalization of a 2D material substrate using Langmuir-Schaefer (LS) conversion as disclosed herein, wherein said functional Langmuir film is designed to be photopolymerized following assembly on the 2D material substrate in order to stabilize the molecular monolayer or thin film following transfer.

In some illustrative embodiments, this present disclosure relates to an apparatus for performing noncovalent functionalization of a 2D material substrate using Langmuir-Schaefer (LS) conversion as disclosed herein, wherein said functional Langmuir film comprises a polymerizable amphiphile comprising both hydrophobic and hydrophilic constituents.

In some illustrative embodiments, this present disclosure relates to an apparatus for performing noncovalent functionalization of a 2D material substrate using Langmuir-Schaefer (LS) conversion as disclosed herein, wherein the transfer is carried out under conditions that lead the molecules of said amphiphile transferred to the 2D material substrate to be converted into a striped phase on the 2D material substrate, wherein said hydrophilic and hydrophobic constituents of the amphiphile are displayed in a regular manner at the interface, creating functional stripes with a pitch regulated by the length of the molecules of said amphiphile.

In some illustrative embodiments, this present disclosure relates to a process for performing noncovalent functionalization of a 2D material substrate using Langmuir-Schaefer (LS) conversion comprising the steps of
a. preparing a molecular monolayer or thin film comprising functional amphiphiles, using a Langmuir trough;
b. preparing a 2D material substrate mounted on the periphery of a thermally regulated disk operable by a motor; and
c. transferring molecules from the monolayer or thin film on the Langmuir trough onto said 2D material substrate by rotation of said thermally regulated disk.

In some illustrative embodiments, this present disclosure relates to a process for performing noncovalent functionalization of a 2D material substrate using Langmuir-Schaefer (LS) conversion as disclosed herein, wherein said process further comprises a step of chemical processing and/or manipulation of said monolayer or thin film to create a multifunctional patterned surface.

In some illustrative embodiments, this present disclosure relates to a process for performing noncovalent functionalization of a 2D material substrate using Langmuir-Schaefer (LS) conversion as disclosed herein, wherein said monolayer or thin film is a polymerizable monolayer or thin film having a controllable wetting characteristics or pattern.

In some illustrative embodiments, this present disclosure relates to a process for performing noncovalent functionalization of a 2D material substrate using Langmuir-Schaefer (LS) conversion as disclosed herein, wherein said process further comprises a step of polymerizing/curing/crosslinking of said functional molecular monolayer or thin film on said supporting 2D material substrate.

In some illustrative embodiments, this present disclosure relates to a process for performing noncovalent functionalization of a 2D material substrate using Langmuir-Schaefer (LS) conversion as disclosed herein, wherein said polymerizing/curing/crosslinking is carried out using the functional molecular monolayer or thin film of polymerizable amphiphiles.

In some illustrative embodiments, this present disclosure relates to a process for performing noncovalent functionalization of a 2D material substrate using Langmuir-Schaefer (LS) conversion as disclosed herein, wherein said polymerization of an amphiphile monolayer or thin film is performed by irradiating with an UV light.

In some illustrative embodiments, this present disclosure relates to a process for performing noncovalent functionalization of a 2D material substrate using Langmuir-Schaefer (LS) conversion as disclosed herein, wherein said polymerizable amphiphile is a polymerizable lipid.

In some illustrative embodiments, this present disclosure relates to a process for performing noncovalent functionalization of a 2D material substrate using Langmuir-Schaefer (LS) conversion as disclosed herein, wherein said polymerizable amphiphile is a single-chain or dual chain polymerizable lipid incorporating one or more functional groups such as carboxylic acids, amines, or phosphates.

In some illustrative embodiments, this present disclosure relates to a process for performing noncovalent functionalization of a 2D material substrate using Langmuir-Schaefer (LS) conversion as disclosed herein, wherein said polymerizable single-chain amphiphile is 10,12-pentacosadiynoic acid or an analog thereof.

In some illustrative embodiments, this present disclosure relates to a process for performing noncovalent functionalization of a 2D material substrate using Langmuir-Schaefer (LS) conversion as disclosed herein, wherein dual-chain amphiphile is 1,2-bis(10,12-tricosadiynoyl)-sn-glycero-3-phosphocholine (diyne PC), 1,2-bis(10,12-tricosadiynoyl)-sn-glycero-3-phosphoethanolamine (diyne PE), or an analog thereof.

In some illustrative embodiments, this present disclosure relates to a process for performing noncovalent functionalization of a 2D material substrate using Langmuir-Schaefer (LS) conversion as disclosed herein, wherein said 2D material substrate is graphene, highly oriented pyrolytic graphite (HOPG), or a layered material, such as a layered material of MoS₂ or W₂.

In some illustrative embodiments, this present disclosure relates to a sub-nanometer-thick coating or functional surface on a 2D material substrate manufactured according to a process comprising the steps of
a. preparing a functional Langmuir film of a monolayer or thin film comprising functional amphiphiles, using a Langmuir trough;
b. preparing a 2D material substrate mounted on the periphery of a thermally regulated disk operable by a motor; and
c. transferring the monolayer or thin film onto said 2D material substrate by rotating said thermally regulated disk by said motor.

In some illustrative embodiments, this present disclosure relates to a sub-nanometer-thick coating or functional surface on a 2D material substrate manufactured according to a process as disclosed herein, wherein said process further comprises a step of chemical processing and/or manipulation of said polymerizable monolayer or thin film to create a multifunctional patterned surface.

In some illustrative embodiments, this present disclosure relates to a sub-nanometer-thick coating or functional surface on a 2D material substrate manufactured according to a process as disclosed herein, wherein said process further comprises a step of chemical processing and/or manipulation of said polymerizable monolayer or thin film before applying said transferring material.

In some illustrative embodiments, this present disclosure relates to a sub-nanometer-thick coating or functional surface on a 2D material substrate manufactured according to a process as disclosed herein, wherein said 2D material substrate is graphene, highly oriented pyrolytic graphite (HOPG), or a layered material of MoS₂ or WS₂.

A longstanding barrier to the broad use of Langmuir transfer methods has been limited throughput, due to the serial nature of transfer and limit on practical trough sizes. Drawing inspiration from roll-to-roll processing techniques used industrially, a few accounts have recently reported LB transfer of nanoparticles from an air-liquid interface across large substrate films.

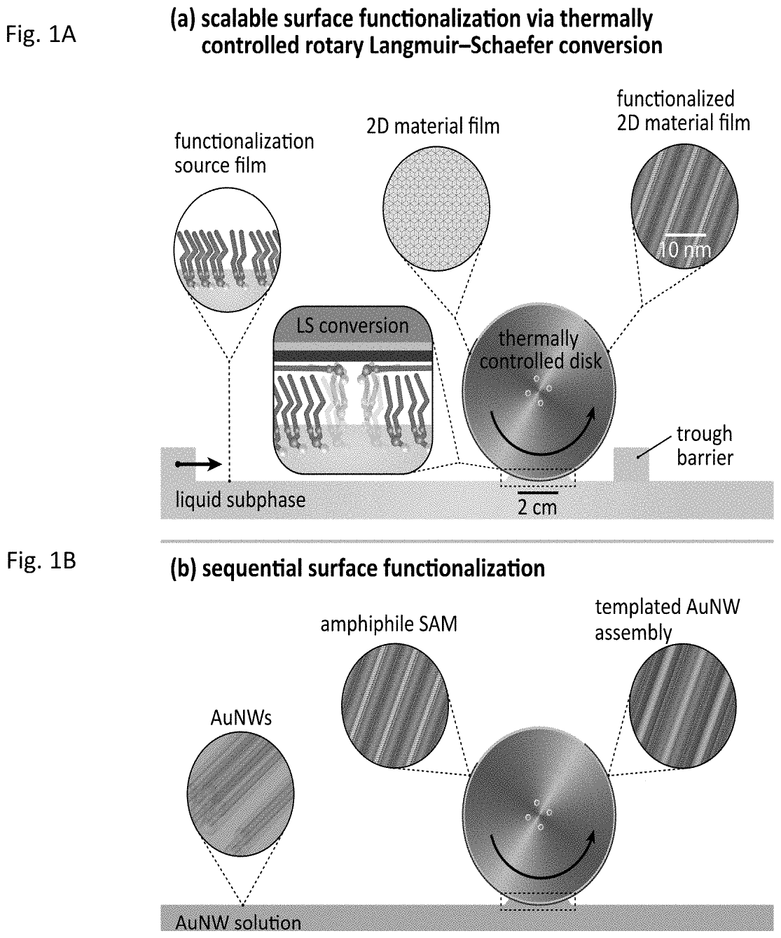

LS conversion has the potential to be an especially good candidate for roll-to-roll processing, since the translation of the receiving substrate across the Langmuir film (FIG. 1A) can in principle contribute to the reordering required to form the lying-down phase. In this work, we designed and built a thermally controlled rotary transfer stage to examine possible contributors to successful roll-to-roll LS conversion (FIG. 1A). The thermally regulated rotary transfer stage enables large-area noncovalent functionalization of 2D materials with lying-down striped phases (˜6 nm periodicity) of amphiphiles (here, photopolymerizable phospholipids), achieving ordered domain sizes up to nearly 10,000 μm². We demonstrate utility of these large-area functional patterns in a subsequent rotary transfer process, assembling ultranarrow gold nanowires (AuNWs) with core diameters <2 nm and average lengths of 300-500 nm (FIG. 1B).

Drawing inspiration from roll-to-roll processing techniques used in the fabrication of solar cells, in this work we designed and fabricated a heated roller apparatus to address the limited throughput associated with LS transfer. The thermally regulated roller enables large-area noncovalent functionalization of 2D materials, achieving ordered domain sizes up to nearly 10,000 μm². We demonstrate utility of these large-area functional patterns in a subsequent roller transfer process, assembling ultranarrow gold nanowires (AuNWs) with diameters <2 nm and lengths up to 1 μm.

As 2D materials are more broadly utilized as components of hybrid materials, controlling their surface chemistry over large areas through noncovalent functionalization becomes increasingly important. Here, we demonstrate a thermally controlled rotary transfer stage that allows areas of a 2D material to be continuously cycled into contact with a Langmuir film. This approach enables functionalization of large areas of the 2D material, and simultaneously improves long-range ordering, achieving ordered domain areas up to nearly 10,000 μm². To highlight the layer-by-layer processing capability of the rotary transfer stage, large-area noncovalently adsorbed monolayer films from an initial rotary cycle were used as templates to assemble ultranarrow gold nanowires from solution. The process we demonstrate would be readily extensible to roll-to-roll processing, addressing a longstanding challenge in scaling Langmuir-Schaefer transfer for practical applications.

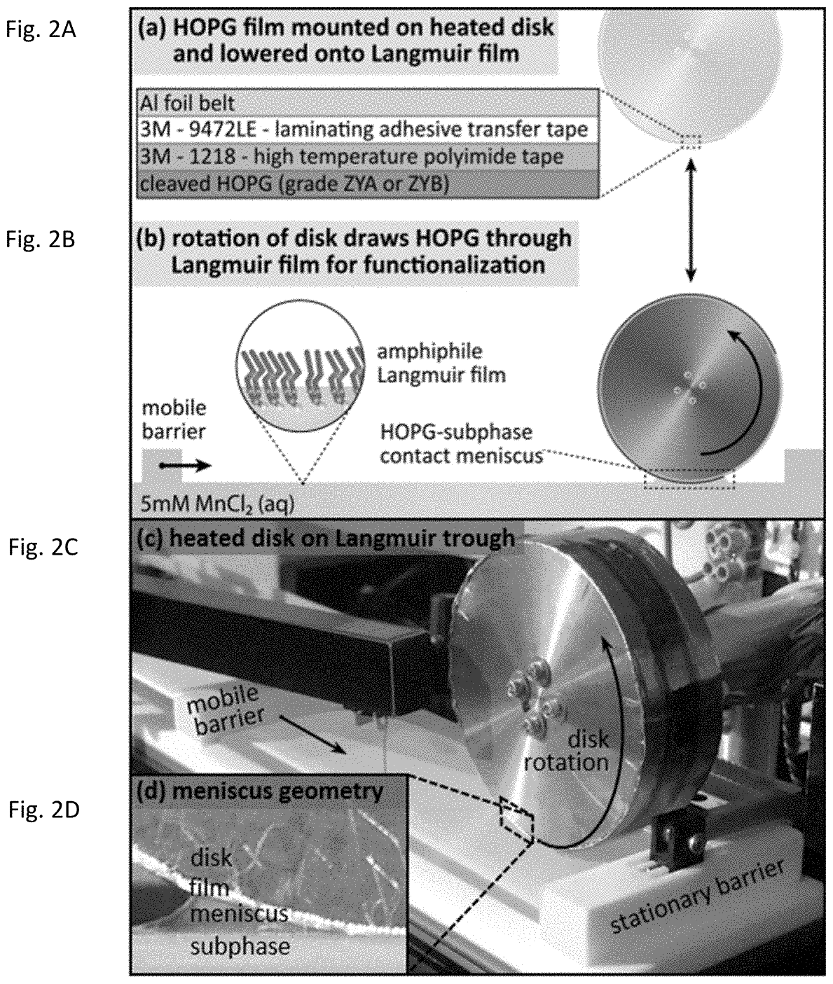

Noncovalent Functionalization of HOPG with Diyne Phospholipids via Thermally Controlled Rotary LS Conversion. To prototype an LS conversion protocol readily extensible to roll-to-roll transfer, we designed a copper disk with four embedded cartridge heaters and a type K thermocouple (FIGS. 2A-2D). The disk was mounted on a translator that allowed it to be lowered into contact with the aqueous subphase, as shown in FIG. 2A. When in contact, the subphase forms a meniscus at the base of the disk (FIGS. 2B (right) and 2D). In order to promote consistent meniscus shapes for each transfer the bottom of the disk was submerged ˜1 mm into the subphase, so that ˜33 mm of the perimeter resides between the advancing and receding fronts of the meniscus during disk rotation.

We have previously shown thermally controlled LS conversion of polymerizable amphiphiles can be achieved on HOPG, MoS₂ and CVD graphene on nickel substrates.^{12,32} For all experiments here, thin films of HOPG cleaved from a bulk substrate were leveraged to create long pliant HOPG films as inexpensive analogues to CVD graphene sheets. The HOPG films were prepared by repeatedly cleaving an HOPG substrate with high temperature polyimide tape; each HOPG tape cleavage was then adhered face up onto a strip of double-sided laminating adhesive tape atop an aluminum foil belt. Subsequently, the belt was mounted firmly around the periphery of the copper disk for noncovalent functionalization (FIGS. 2A-2C). More details on film preparation can be found in the Experimental Methods section.

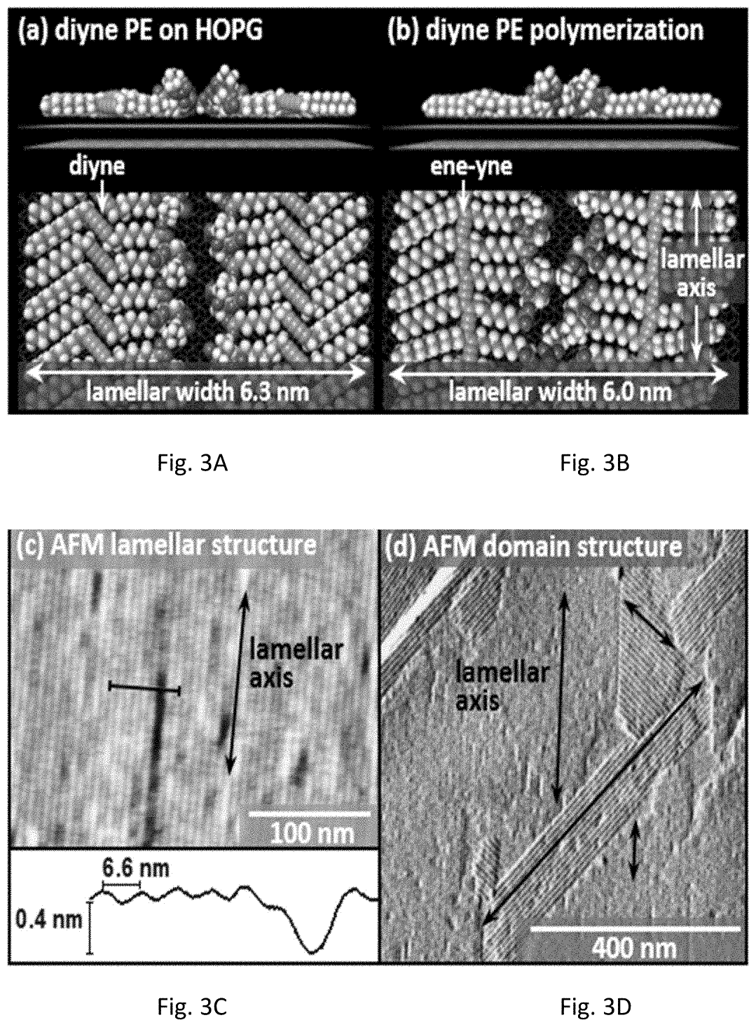

In this study, striped phases of the photopolymerizable amphiphile 1,2-bis(10,12-tricosadiynoyl)-sn-glycero-3-phosphoethanolamine (diyne PE, FIGS. 3A-3D) were prepared using the new rotary translation stage under LS conversion conditions previously reported by our group,^{9,32} in a transfer process we refer to as thermally controlled rotary LS conversion (TCR-LS conversion). For all TCR-LS conversions of diyne PE to HOPG films performed in this manuscript, the temperature of the HOPG surface was maintained at 80±3° C.; the setpoint temperature was chosen based on results achieved previously utilizing a non-rotary thermally controlled LS conversion stage. The elevated temperature promotes long-range ordering of assembled molecular domains, and nearly complete monolayer surface coverage of striped phases, which in our experience results in minimal retention of subphase as the trailing edge of the HOPG film emerges from the receding front of the meniscus.

Since the motion of the thermally controlled disk is directional in TCR-LS conversion (here, counterclockwise, FIG. 2B), transfers were carried out in a single-barrier compression geometry (FIG. 2C, mobile barrier is false-colored green; stationary barrier false-colored red). To assess whether the LS conversion process is impacted (e.g. monolayer surface coverage, relative domain sizes) by the translation rate of the HOPG belt across the amphiphile source film, substrate film translation rates of 1.10 mm/s, 0.54 mm/s, and 0.14 mm/s were tested.

As observed previously with the non-rotary thermally controlled transfer stage, standing phases of diyne PE assembled on an aqueous subphase can be transferred to form noncovalently adsorbed lying-down striped phases on the HOPG belt using TCR-LS conversion. Molecular models in FIGS. 3A and 3B illustrate the lamellar structure of diyne PE on HOPG, both before (FIG. 3A) and after (FIG. 3B) photopolymerization. Atomic force microscopy (AFM) images show lamellar periodicity of unpolymerized TCR-LS converted diyne PE on HOPG (FIG. 3C). Larger-scale AFM images (FIG. 3D) illustrate pre-polymerization diyne PE domain structure; domains orient in epitaxy with the hexagonal HOPG lattice (black arrows), resulting in ˜120° angles between domains. At μm scales, topographic features on the HOPG surface begin to obscure features in the monolayer structure, since the 0.34 nm thickness of each HOPG layer is similar to the thickness of the monolayer.

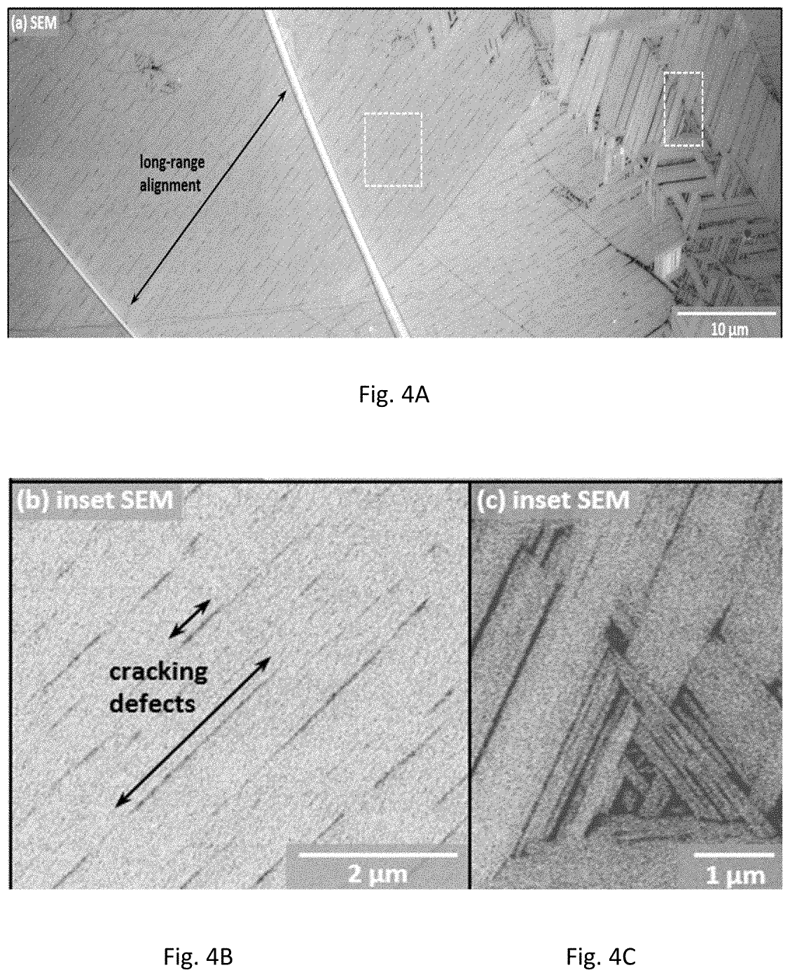

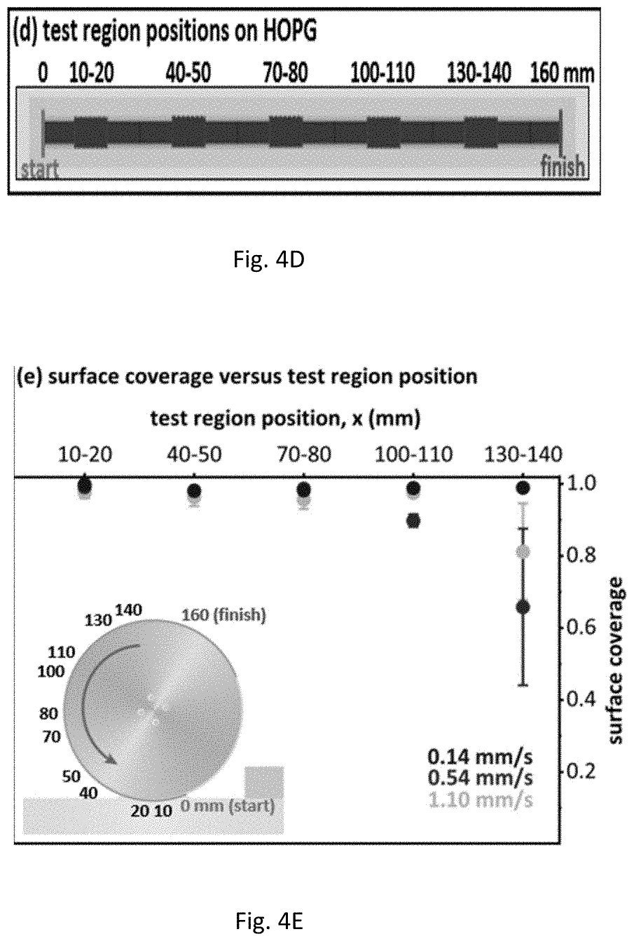

Previously, we have found that it is possible to resolve structural details of these monolayers by scanning electron microscopy (SEM), based on a combination of large contrast differences between the thin (<1 nm), predominantly insulating monolayer, and the more conductive HOPG substrate. The presence of polymerization-induced cracking defects serve to highlight the lamellar row orientation (FIGS. 4A, 4B). Here, SEM images in FIGS. 4B and 4C show monolayer diyne PE domains at a scale comparable to the AFM image in FIG. 3D, to highlight the similar information that can be derived regarding both molecular domain structure and surface coverage. Throughout the rest of the manuscript, characterization is based primarily on large-area SEM images.

Comparison of Surface Coverage and Molecular Domain Morphologies Based on Stage Translation Rate. The rotation rate of the transfer stage determines both the length of time each point on the HOPG surface spends in contact with the Langmuir film, as well as the rate of translation of the HOPG surface through the leading edge of the meniscus bearing the Langmuir film (FIG. 2D). To examine whether either of these factors contributed to domain ordering, we tested a range of rotation rates chosen to produce substrate translation rates of 0.14-1.10 mm/s, equivalent to HOPG-Langmuir film contact times of 4 min to 30 s. Contact time is calculated as the time required for a point on the disk surface to travel between the leading and trailing edges of the HOPG-subphase meniscus.

Functionalization was examined in evenly spaced testing zones with x coordinates from 10-20 mm (in the first segment of HOPG to contact the Langmuir film as the disk is lowered) to 130-140 mm. For all tested translation rates, we observed nearly complete surface coverage of striped phases (>95%) in regions up to 80 mm along the HOPG strip (FIG. 4D). In the last two test regions (100-110 mm and 130-140 mm), the slowest translation rate (0.14 mm/s) maintained nearly complete surface coverage (>98%); however, there appears to be a threshold speed between 0.14-0.54 mm/s at which surface coverage begins to decrease. This finding may be consistent with a limited rate at which the Langmuir film can restructure to refill the area of the film depleted by the transfer stage, potentially reducing local surface pressure in that area although the setpoint surface pressure for the trough is maintained (std. dev. ±0.4 mN/m) during transfer.

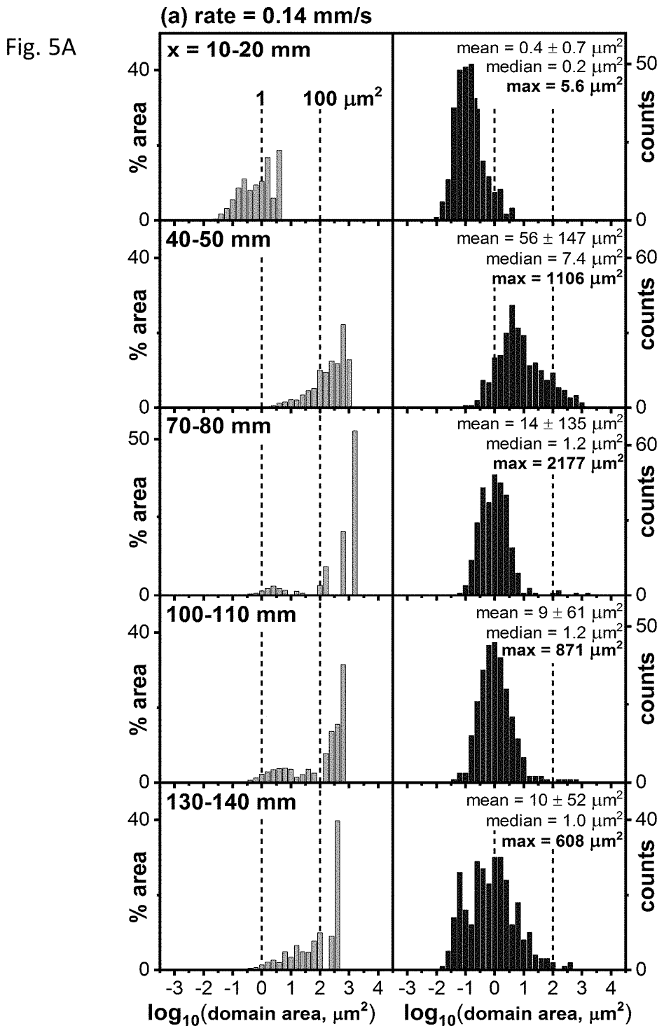

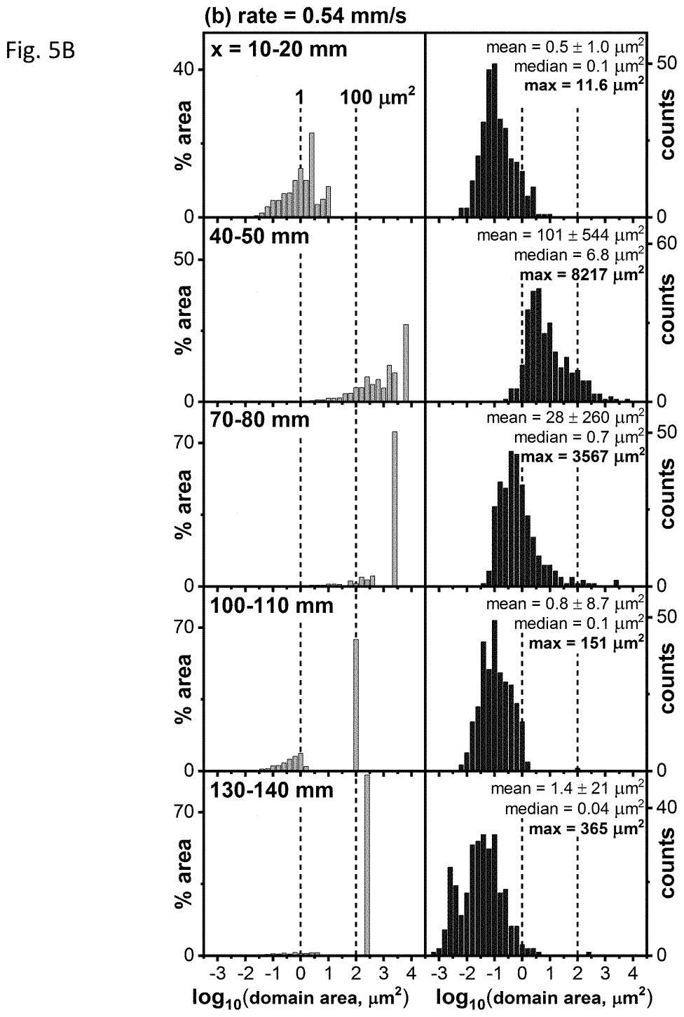

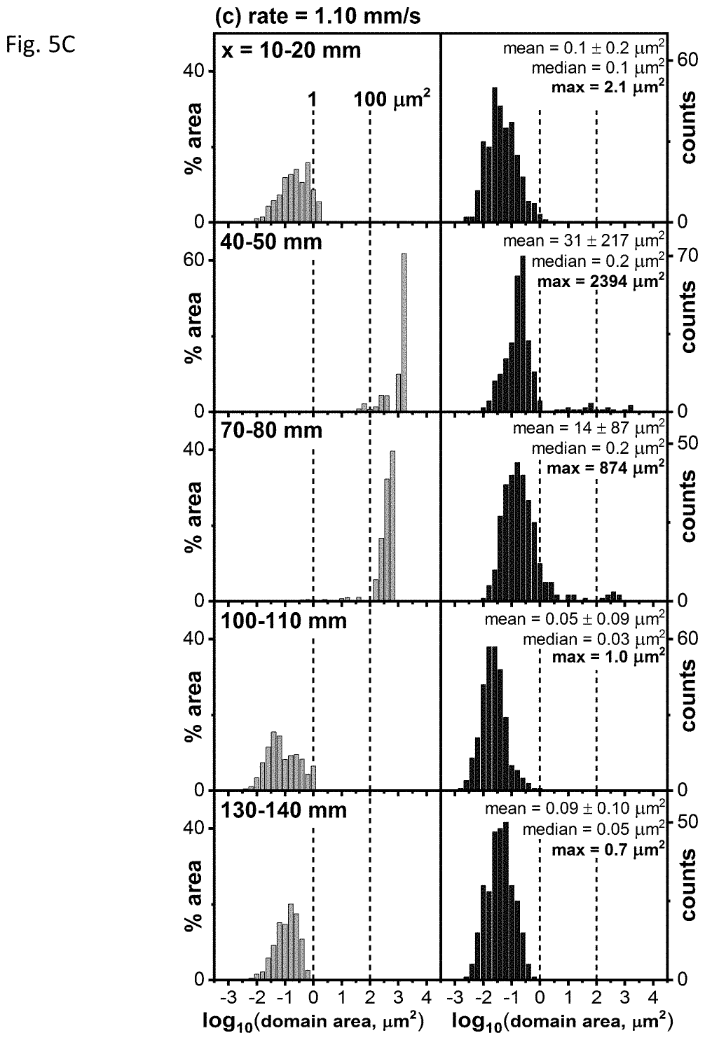

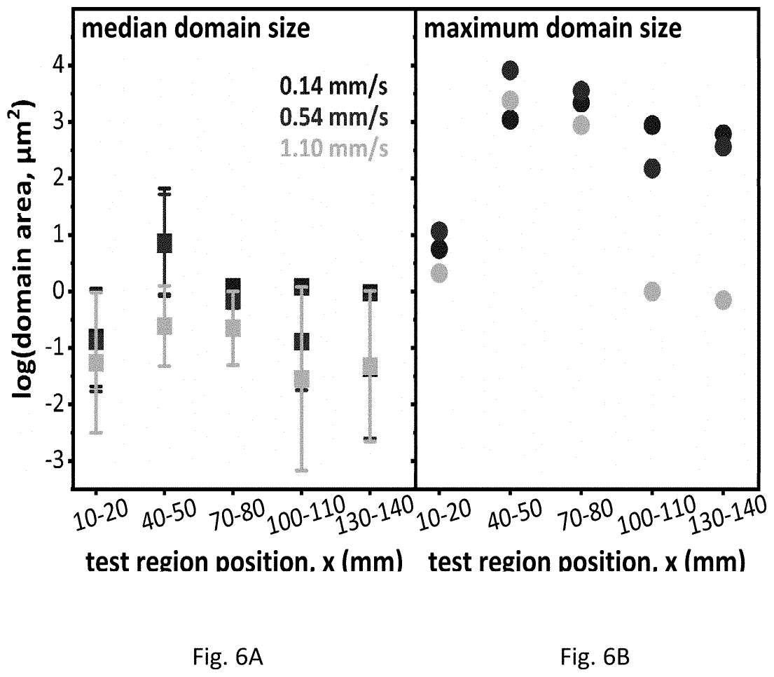

Both stage translation rate and linear position along the transfer path impacted the distribution of molecular domain sizes (FIGS. 5A-5C). Measured domain sizes varied by several orders of magnitude, from <0.01 μm² to >8000 μm², frequently requiring manual image segmentation to detect domain edges. To quantify the extent of molecular ordering observed at points along the transfer path, we segmented contiguous blocks of 100 domains in each of three representative SEM images selected from three discretely spaced locations within each of the five testing zones along the transfer path. For each HOPG translation speed (0.14 mm/s (left), 0.54 mm/s (center), 1.10 mm/s (right)), this generated a set of 300 domain areas. Each set is represented in two ways in FIGS. 5A-5C—first, as a fraction of the total surface area occupied by domains in a given size range (gold bars), and second, as a histogram of the frequency with which domains in a given size range were observed (blue bars). As a guide to the eye, 1 μm² and 100 μm² areas are indicated by a pair of dotted lines in each histogram. Calculated mean values for each test region were often very different from median values, and had large associated standard deviations, consistent with skewed distributions. The median absolute deviation (MAD, the interval from the 25^{th}-75^{th} percentile of the distribution), is a measure of dispersion of data that is insensitive to outliers, and therefore, was utilized to describe the median domain size distributions in FIG. 6A.

Median (FIG. 6A) and maximum (FIG. 6B) observed domain sizes suggest substantial advantages associated with translation of the stage during transfer. The first test zone (10-20 mm) is in the region lowered into contact with the Langmuir film. Small median domain sizes (0.1-0.2 μm²) were observed for all three translation rates in the 10-20 mm test zone, with maximum observed individual domain areas 2.1-11.6 μm². Regions of the HOPG film brought into contact with the Langmuir film through rotation of the transfer stage (x=30-140 mm) primarily exhibited much larger molecular domains (median domain areas up to 7.4 μm²), with domain sizes >100 μm² routinely observed, and occasional domains with areas approaching 10,000 μm². In most cases, domains were largest for x=40-50 mm (the first translated test region) and decreased in later test zones along the transfer path.

Maximum domain areas (FIG. 6B) were typically orders of magnitude greater than the median values, and did not exhibit a clear dependence on translation rate. While median domain sizes exhibited some correlation with translation rate (larger domains associated with slower translation), all three translation rates produced similar maximum domain sizes for x=40-50 mm and 70-80 mm, with similar sizes for slow (0.14 mm/s) and medium (0.54 mm/s) transfer rates through the end of the test strip (140 mm). Since the sizes of large domains do not correlate strongly with either median domain size or surface translation rate, we suggest that very large ordered molecular domains on HOPG may arise through transfer of molecules from large ordered molecular domains in the Langmuir film. This possibility could also be consistent with observed morphological features of large ordered domains of diyne PE on HOPG. For instance, in the large ordered area of diyne PE that occupies much of the SEM image in FIG. 4A, molecular ordering extends across several step edges, including at least two that are tall enough to cause significant electron scattering (bright features running from upper left to lower right), and across two sets of HOPG terraces with a rotational offset (rotational offset boundary extends from upper left to lower right, in the ordered area). Smaller domains observed in later test regions would be consistent with shorter-range ordering in the Langmuir film in the area near the leading edge of the transfer stage, as molecules are withdrawn onto the HOPG and the Langmuir film restructures to maintain surface pressure.

Overall, the surface coverage and molecular domain size analyses indicate high degrees of coverage for all tested translation rates. However, for applications in which surface coverage must be very near 100%, or that benefit from uniformly larger ordered domains (as evidenced by small MAD values near the end of the HOPG film), slow translation rates (here, 0.14 mm/s) may be beneficial.

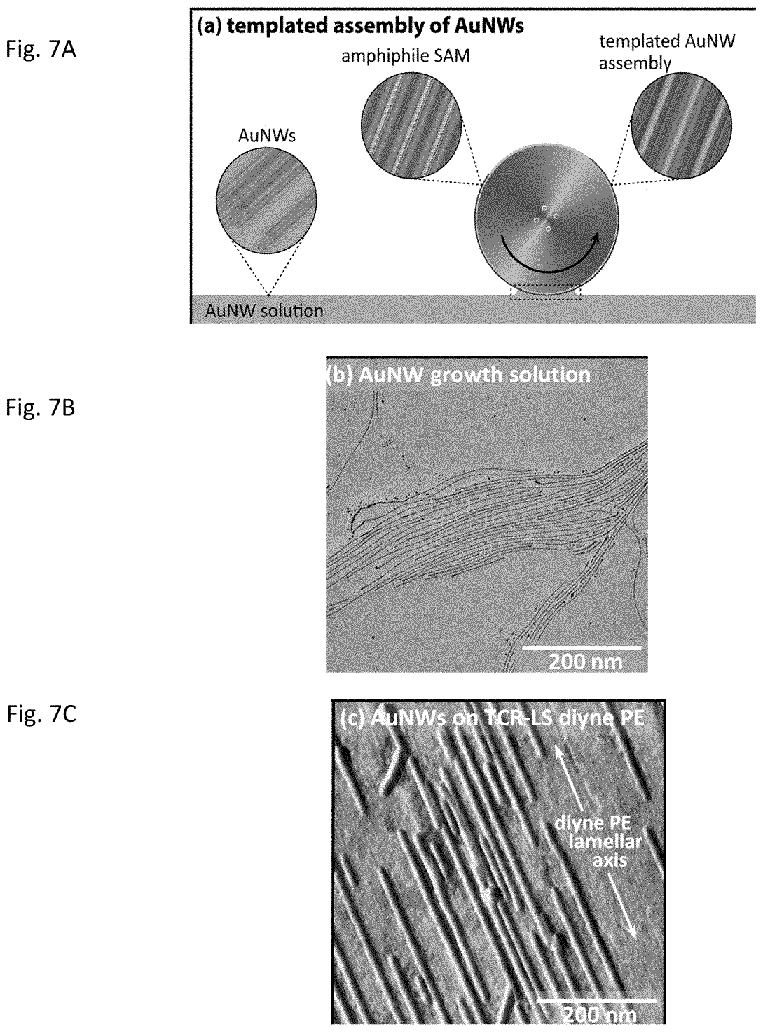

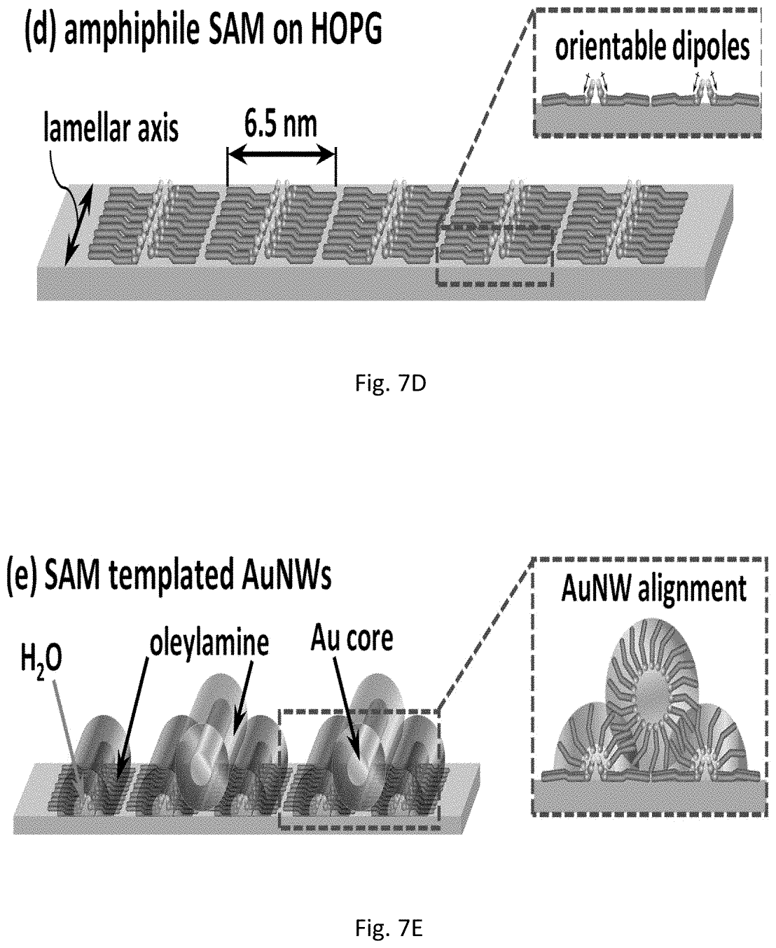

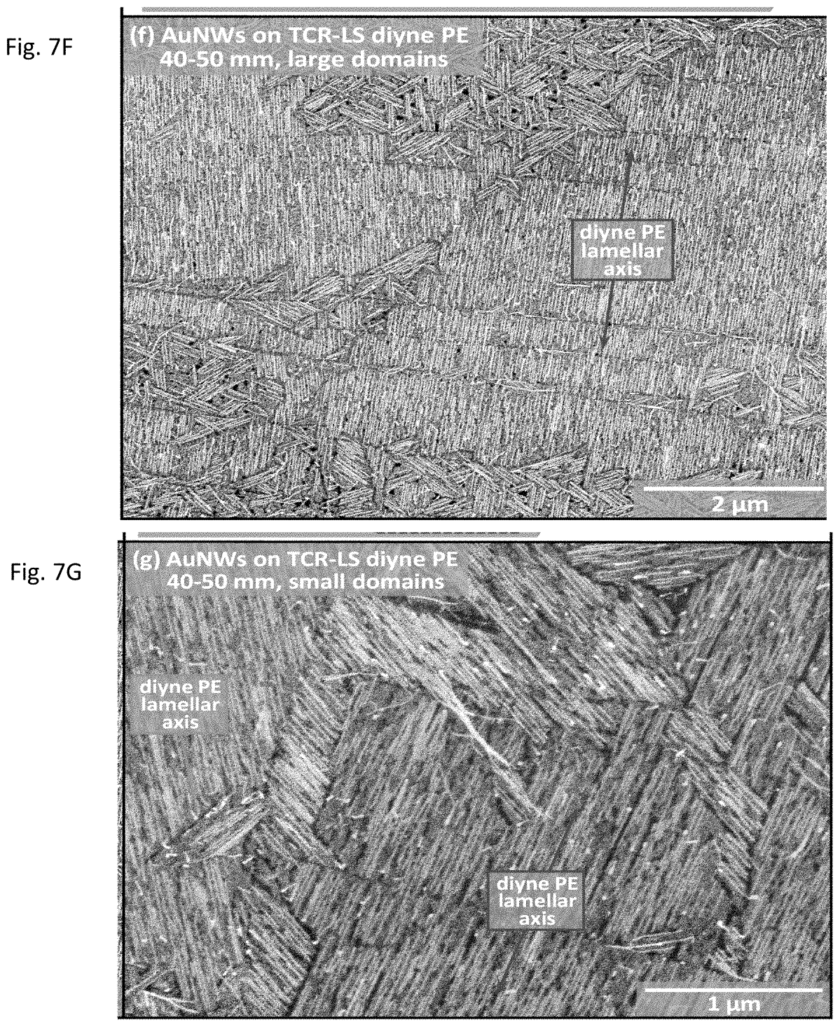

Sequential Rotary Transfer of Gold Nanowires to TCR-LS Converted Diyne PE Monolayer Template Films. Because physical properties of nanocrystals (e.g. plasmon resonance wavelengths) and their coupling between nanocrystals vary with particle orientation and interparticle distance, controlling ordering and orientation of anisotropic nanocrystals is a sigificant goal in next-generation materials. Both the assembly of high-aspect ratio particles (here, >200:1) and achieving interparticle spacings independent of nanocrystal ligand shell thickness is difficult using most superlattice assembly methods. For instance, the most common strategies, based on slow evaporation of solvent, rely on shape complementarity and contact between ligand shells to induce ordering. However, recently, we have demonstrated that striped phases of diyne PE can be utilized to generate well-ordered arrays of long (up to 1 μm), flexible AuNWs Here, we demonstrate the assembly of AuNWs on diyne PE striped phases first assembled on long HOPG films via TCR-LS conversion (FIG. 7A), using rotary transfer in both steps to increase the surface area of functionalization while providing large areas of ordered template surface.

AuNWs were synthesized using a previously reported procedure (Porter, A. G. et al., Chem 2019, 5, 2264-2275),⁴⁵ which produces flexible nanowires with metal core diameters of 1.5-2 nm (FIG. 7B), with oleylamine ligand shells. Previously we have demonstrated that these flexible narrow wires interact with striped diyne PE surface templates containing arrays of orientable dipoles (FIG. 7D), forming highly aligned arrays of individual AuNWs (FIGS. 7C, 7E), in a process that appears to involve polarization of the Au core to create repulsive interactions between the wires.

Here, following TCR-LS assembly of a striped template of diyne PE on HOPG (FIG. 7D), we lowered the rotating translation stage into contact (unheated, translation rate of 0.02 mm/s) with a reservoir of AuNW solution. This process generates large areas of highly aligned individual AuNWs on the template surface (FIG. 7F). FIGS. 7F and 7G highlight the significance of domain size in orienting the flexible AuNWs over a given area of the diyne PE SAM template. Diyne phospholipid amphiphiles orient in epitaxy with the hexagonal HOPG lattice, resulting in ˜120° angles between domain lamellar axes. In FIG. 7G, two small diyne PE domains with different lamellar axes have been false colored green and red as a guide to the eye. Within both domains, the flexible AuNWs (observed as lighter contrast lines against the darker contrast diyne PE template) orient along the lamellar axes of the diyne PE domains. The flexibility of the AuNWs can be observed in FIG. 7B, and within the red domain, in wires adsorbed out of alignment with the lamellar axis (indicated with red arrow). A large area of a diyne PE SAM template that is comprised of small domains would have poor overall unidirectional alignment of AuNWs. Conversely, FIG. 7F highlights the ability of large unidirectional diyne PE domains. Here, the perimeter of a large domain has been highlighted in red, with small inclusion domains with different lamellar axis direction highlighted in green) to orient AuNWs along a single axis over a large area of the molecular template. AuNW coverage extended the entire length of the HOPG film, illustrating the capacity of the template to scalably guide heterostructured interface assembly.

To summarize, we have shown that, using a temperature-controlled, variable-speed rotating transfer stage, it is possible to perform large-area functionalization of 2D materials with amphiphilic molecules via LS conversion. This approach produces very large (nearly 10,000 μm²) ordered molecular domains, and can subsequently be used to direct assembly of other nano structures (here, ultranarrow AuNWs). These findings lay foundations for the use of roll-to-roll transfer methods to leverage LS conversion for surface functionalization of 2D materials. Such a capability is potentially advantageous in applications that require large areas of functional surface, or benefit from long-range ordering within the functional film.

### EXPERIMENTAL METHODS

Materials. Absolute ethanol (100% purity) was purchased from Decon Labs, Inc. (King of Prussia, Pa.) and used as received. Methylene chloride (HPLC grade, ≥99.9% purity) and 2-propanol (HPLC grade, ≥99.9% purity) were purchased from Fisher Scientific, Fair Lawn, N.J.) and used as received. Tetrachloroauric(III) acid trihydrate (ACS reagent grade, ≥49.0% Au purity) and cyclohexane (99.5% purity, extra dry) were purchased from ACROS Organics (Fair Lawn, N.J.) and used as received. Chloroform (reagent grade, ≥99% purity), manganese (II) chloride tetrahydrate (dry basis, ≥98% purity), oleylamine (technical grade, 70% purity), triisopropylsilane (TIPS) (98% purity), and molecular sieves (4 Å) were purchased from MilliporeSigma (St. Louis, Mo.) and used as received. 1,2-bis(10,12-tricosadiynoyl)-sn-glycero-3-phospho-ethanolamine (diyne PE) (>99.0% purity) was purchased from Avanti Polar Lipids, Inc. (Alabaster, Ala.) and used as received. Large highly oriented pyrolytic graphite (HOPG) substrates (grade ZYA, 20-mm×30-mm×2-mm) were purchased from Momentive Performance Materials Quartz, Inc. (Strongsville, Ohio); smaller HOPG substrates (grade ZYA and ZYB, 10-mm×10-mm×1-mm) were purchased from MikroMasch (Watsonville, Calif.). Aluminum foil was purchased from Fisher Scientific (Fair Lawn, N.J.). Adhesive transfer tape (3M product 9472LE), and high temperature polyimide tape (3M product 1218), were purchased from Digi-Key (Thief River Falls, Minn.). PELCO colloidal silver, 20-mm AFM metal specimen discs, standard SEM pin stub mounts, and double coated carbon conductive tape were purchased from Ted Pella, Inc. (Redding, Calif.). 0.01-0.025 Ω·cm Antimony (n)-doped Si Bruker RFESP-75 probes (nominal force constant 3 N/m and radius of curvature <12 nm) purchased from Bruker AFM Probes (Camarillo, Calif.) along with 0.01-0.025 Ω·cm (n)-doped silicon MikroMasch HQ:NSC18/No Al probes (nominal force constant 2.8 N/m and with 8 nm radius of curvature) purchased from MikroMasch USA (Watsonville, Calif.) were used as received. Milli-Q water (≥18.2 MΩ·cm resistivity) was used in all experiments. Ultra-high purity nitrogen (99.999% purity) was purchased from Indiana Oxygen Company (Indianapolis, Ind.).

Instrumentation. Self-assembled monolayers of diyne PE were prepared on a Kibron Langmuir-Blodgett trough (Helsinki, Finland). Atomic force micrographs were acquired using either a Veeco MultiMode AFM with NanoScope V controller (Bruker Instruments, Billerica, Mass.) or an Agilent 5500 AFM/SPM (Agilent Technologies, Inc., Palo Alto, Calif.). Scanning electron micrographs were acquired using a Teneo VS SEM (Thermo Fisher Scientific, Hillsboro, Oreg.). Transmission electron micrographs were acquired using a Tecnai G2 20 TEM (Thermo Fisher Scientific, Hillsboro, Oreg.).

Design of TCR-LS Transfer Stage. The thermally controlled rotary (TCR) LS transfer stage was designed and fabricated to allow a 3.0-in diameter×1.0-in thick copper disk to rotate with programmable speed and temperature during Langmuir-Schaefer transfer. The copper disk was machined to house a type-K thermocouple along with 4 evenly spaced 20-W cartridge heaters connected in parallel. An external Omega temperature controller was used to regulate the input power supplied to the cartridge heaters, enabling the surface of the substrate to be maintained at a specified setpoint temperature. Rotation of the copper disk was achieved using a brushless DC motor with a 200:1 gear head and programmable driver allowing a minimum shaft speed of 0.005 RPM, corresponding to a transit rate of 0.02 mm/s for the surface of the copper disk being drawn along the Langmuir film.

Preparation of Flexible HOPG Substrate Films. To enable LS conversion of standing phases into lying-down phases over large substrate areas using the TCR-LS transfer stage, pliant HOPG films were prepared to accommodate the curved surface of the copper disk (FIG. S2). First, a sheet of aluminum foil was affixed to the benchtop to provide a clean working surface. Next, a second sheet of aluminum foil was folded to form a 1.0-in wide belt (width of copper disk) and affixed at both ends to the first aluminum foil sheet. The top surface of the aluminum foil belt was then cleaned with 2-propanol to remove trace oils from its manufacturing process. Laminating adhesive transfer tape (3M product 9472LE) was cut to a desired length and affixed to the aluminum belt, with pressure from a weighted roller to ensure uniform contact.

Next, grade ZYA or ZYB HOPG was cleaved with high temperature polyimide tape (3M product 1218). Two parallel edges of the tape were carefully trimmed to ensure no adhesive was exposed between HOPG segments; each piece of trimmed polyimide tape was then affixed to the adhesive transfer tape with the edges of HOPG segments adjoined to form a contiguous film. The cleaving, cutting, and adhering cycle was repeated until the desired length of HOPG film was achieved. In early prototyping experiments using double-sided copper tape and Scotch tape, we observed that small molecular aggregates atop domains of diyne PE, which we attributed to leaching of exposed adhesive. In subsequent transfers, we utilized thermally stable 3M tapes (laminating adhesive transfer tape 9472LE and high temperature polyimide tape 1218); additionally, a layer of polyimide tape was placed adhesive side down over exposed tape edges along the long axis of the belt to prevent adhesive from contacting the Langmuir film. Finally, the top surface of the belt, excluding the freshly mounted HOPG cleaves, was cleaned a final time with 2-propanol.

TCR-LS Conversion of Diyne Phospholipids. Monolayers of noncovalently adsorbed diyne PE on HOPG were prepared via TCR-LS conversion under single barrier compression on a Kibron Langmuir-Blodgett trough. All sample handling steps were performed under UV-filtered light to minimize photopolymerization. The trough and barriers were thoroughly cleaned with ethanol and water prior to the addition of a 5 mM MnCl₂ in Milli-Q water subphase. After cleaning the subphase through repeated barrier compression and aspiration, the subphase was heated to 30° C. using a ThermoTek T255P chiller and held at this temperature throughout the TCR-LS transfer. The Kibron trough was initialized to 21635 mm² and reduced in area to 21,000 mm² for each rotary LS conversion experiment to provide room for the temperature probe to be inserted between the outside edge of the left barrier and the wall of the trough.

To improve amphiphile source film uniformity, 60 μL of 0.50 mg/mL diyne PE in CHCl₃ was spread evenly in a grid across the subphase, in 1-μL droplets, from the left barrier to the right barrier. The trough was equilibrated for 30 min to allow the CHCl₃ spreading solvent to evaporate. Following equilibration, single barrier compression of the phospholipid film was initiated by sweeping the left barrier in at 6.10 mm/min towards the right (stationary) barrier, until a target surface pressure of 30 mN/m was achieved. Once the target surface pressure was reached, the source film was maintained at 30 mN/m for 30 min while the flexible HOPG substrate film was prepared prior to mounting the substrate film, the copper disk of the heated roller transfer stage was washed 3× with hexane and ethanol, and once with 2-propanol, to remove any residual tape adhesive or subphase salts from previous transfers.

All TCR-LS conversions were performed with substrate set point surface temperatures of 80±3° C., as measured by an Analogic Digi-Cal II thermocouple calibrator, model AN6520, placed in direct contact with the substrate prior to deposition. Following mounting and heating of the substrate film on the copper disk, the TCR transfer stage was positioned next to the Kibron trough with the copper disk adjacent to the right barrier, and the bottom edge of the disk several mm above the trough. The copper disk (and mounted HOPG film) was lowered into contact with the Langmuir film, using the z-axis translation stage. The wheel was then rotated counterclockwise at shaft rotation rates calculated to cause the HOPG to translate across the Langmuir film at rates of 1.10 mm/s, 0.54 mm/s or 0.14 mm/s, corresponding to HOPG-Langmuir film contact times of 30 s, 1 min, and 4 min, respectively. Once the trailing edge of the HOPG film emerged from the receding HOPG-subphase contact meniscus, rotation was halted, and the copper disk was raised out of contact with the subphase. The surface pressure sensor typically registers a brief increase in surface pressure of the Langmuir film when the rotary transfer stage initially contacts the trough, but otherwise maintains the setpoint pressure (typical standard deviation 0.3-0.4 mN/m) throughout transfer.

Following each TCR-LS conversion transfer of diyne PE to HOPG, the pliant HOPG belt was removed from the copper wheel, flattened, and gently blown dry with ultra-high purity nitrogen. Upon drying, the functionalized HOPG was placed under a 254 nm 8-W UV lamp for 1 h to initiate photopolymerization of the diacetylene groups in the functional molecular layer. The distance between the lamp and the sample surface was approximately 4 cm.

Sequential Rotary Transfer of AuNWs to TCR-LS Converted Diyne PE Monolayer Films. Sequential surface functionalization of TCR-LS transferred diyne PE monolayers with AuNWs was achieved via a roll-to-roll inspired processing technique in a humidity-controlled enclosure within a fume hood. First, the copper disk of the heated roller was cleaned thoroughly with three cycles of hexane and ethanol—ending with one rinse of 2-propanol—to remove any residual tape adhesive, subphase salts, or AuNW growth media and wires from previous experiments. Next, a petri dish was cleaned with DI water and soap, followed by three thorough rinse cycles of hexane and ethanol, and placed in an oven set to 130° C. for 30 min to dry. While the petri dish was in the oven, an aluminum lab jack was placed alongside the heated roller transfer stage. Next, the TCR-LS diyne PE monolayer belt was removed from the vacuum desiccator it was held in overnight.

Once removed from the vacuum desiccator, the diyne PE monolayer belt was tightly mounted to the TCR transfer stage with 3M high temperature polyimide 1218 tape. To remove any adhesive residues transferred to the top edges of belt from handling the tape during mounting, a Kimwipe saturated with 2-propanol was run down the edges of the film atop the downward facing polyimide tape (see Preparation of flexible HOPG substrate films above). Once the film was mounted, the petri dish was retrieved from the oven and place atop the aluminum lab jack to cool. A humidity logger (Onset HOBO MX1101 temp/RH logger) was placed next to the petri dish atop the aluminum jack. While the petri dish cooled, the humidity control enclosure was placed over the TCR apparatus and purged with nitrogen gas until the relative humidity fell within the range of 15%±2% RH.

Upon reaching the desired 15%±2% RH range, the humidity enclosure was briefly raised to allow 50 mL of the 14.5-h aged AuNW growth solution to be added to the petri dish. Once the humidity control box was repositioned over the TCR stage, the enclosure was sealed airtight to the fume hood benchtop with duct tape, allowing the relative humidity to quickly re-equilibrate to ˜15%. Next, the floor jack was raised in order to bring the AuNW growth solution into contact with the diyne PE monolayer film. The disk was then rotated counterclockwise in the same motion as the initial transfer cycle. The linear velocity of the disk was set to 0.02 mm/s.

To obtain uniform AuNW surface density across the entire length of the TCR-LS diyne PE monolayer film, 5 mL of “used” (from the petri dish) AuNW solution was removed and replaced with 5 mL of “fresh” (from remaining 50 mL of the 14.5-h aged AuNW solution prepared for experiment) AuNW solution every 12 min via a 10-mL syringe through a small hole in the humidity enclosure. The relative humidity throughout the rotary transfer was measured at 14.3%±0.7% RH.

After the last portion of the TCR-LS diyne PE monolayer film passed through the receding diyne PE/AuNW growth solution contact meniscus, the belt was brought out of contact with the AuNW solution by lowering the lab jack. Following the removal of the film from the copper disk, the film was washed with 1 mL cyclohexane (growth solution solvent) per 10-mm segment of film to ensure any excess oleylamine capping ligands were removed from the film.

AuNW synthetic protocol. AuNWs were prepared utilizing a synthetic procedure outlined below,⁴⁶ to generate AuNW solutions appropriate for deposition on diyne PE templates. To generate adequate growth solution for rotary transfer of AuNWs to TCR-LS transferred diyne PE monolayer films, two identical reactions were carried out in the manner described below. First, molecular sieves were added to a mixture containing 2.5 mg of HAuCl₄.3H₂O and 2.2 mL of dry cyclohexane at ambient temperature. Oleylamine (84 μL) was added and the reaction and was briefly agitated using a vortex mixer. Next, triisopropylsilane (120 μL) was added, and the solution was promptly sealed and mixed again. The reaction mixture was then transferred to a humidity-controlled environment to age at ambient temperature for 14.5 h. After aging, the two reaction mixtures were combined and then diluted by a factor of 34 with dry cyclohexane to reach a final volume of 100 mL.

AFM Imaging. All standard AFM measurements and micrographs were acquired using either a Veeco MultiMode with Nanoscope V controller (Bruker Instruments, Billerica, Mass.) in tapping mode with 0.01-0.025 Ω·cm Antimony (n)-doped Si Bruker RFESP-75 probes (nominal force constant 3 N/m and radius of curvature <12 nm), or an Agilent 5500 AFM/SPM (Agilent Technologies, Inc., Palo Alto, Calif.) in tapping mode with 0.01-0.025 Ω·cm (n)-doped silicon MikroMasch HQ:NSC18/No Al probes (nominal force constant 2.8 N/m and with 8 nm radius of curvature).

TEM Imaging. All TEM images were acquired from a Tecnai G2 20 (Thermo Fisher Scientific, Hillsboro, Oreg.) with a lanthanum hexaboride (LaB₆) filament at an accelerating voltage of 200 kV. TEM grids were prepared by dropping 5 μL of the AuNW solution on a copper grid covered by a carbon film.

SEM Imaging. Scanning electron micrographs were acquired using a Teneo VS SEM (Thermo Fisher Scientific, Hillsboro, Oreg.). Samples were cut from the pliant HOPG films and mounted onto 20-mm AFM metal specimen discs with double coated carbon conductive tape. PELCO colloidal silver was applied around the sample perimeter to provide enhanced electrical contact between the sample and the specimen disc, minimizing surface charging during SEM imaging. Samples on specimen discs were then mounted to standard SEM pin stub mounts with double coated carbon tape. High resolution imaging of horizontally-oriented striped phase SAMs and surface-templated AuNW arrays prepared by rotary transfer was achieved using the in-column Trinity detector T3 in OptiPlan mode at working distances of 5-6 mm. Beam currents in the range of 0.20-0.80 nA were selected for best resolution image acquisition through a 32-μm diameter aperture with an accelerating voltage of 5.00 kV.

SEM Image Analysis. Functionalization was examined in five evenly spaced testing zones along the flexible HOPG substrate film, as described in the manuscript. X coordinates were 10-20 mm (the first segment of HOPG to contact the Langmuir film as the disk is lowered), 40-50 mm, 70-80 mm, 100-110 mm, and 130-140 mm (last segment). To quantify the surface coverage of the diyne PE monolayer along the flexible HOPG film for each of the three translation rates tested, low magnification (5,000×, 82.9 μm HFW) SEM images were acquired from three discrete locations within each of the five testing zones. We then selected the most representative low magnification image from each of the three discrete imaging locations and masked unfunctionalized areas within each image via color thresholding in ImageJ. Quantification of masked pixel area per SEM image allowed us to calculate the average surface coverage and its associated standard deviation (FIG. 4E) for each of the five testing zones (FIG. 4D).

Molecular Modeling. Software packages Maestro and Macromodel (Schrödinger, Cambridge, Mass.) were used, respectively, to visualize the structures of diyne phospholipids on graphene and to perform force field minimizations. All models were simulated using the OPLS_2005 force field, with implicit water solvent file and extended cutoffs for van der Waals, electrostatic, and hydrogen-bonding interactions. Minimizations were performed using the Polak-Ribiere conjugate gradient (PRCG) algorithm and gradient method with 50,000 runs and a convergence threshold of 0.05.

Those skilled in the art will recognize that numerous modifications can be made to the specific implementations described above. The implementations should not be limited to the particular limitations described. Other implementations may be possible.

It is intended that the scope of the present methods and apparatuses be defined by the following claims. However, it must be understood that this disclosure may be practiced otherwise than is specifically explained and illustrated without departing from its spirit or scope. It should be understood by those skilled in the art that various alternatives to the embodiments described herein may be employed in practicing the claims without departing from the spirit and scope as defined in the following claims.

### REFERENCES CITED

(1) Wang, Q. H.; Kalantar-Zadeh, K.; Kis, A.; Coleman, J. N.; Strano, M. S. Electronics and Optoelectronics of Two-Dimensional Transition Metal Dichalcogenides. Nat. Nanotechnol. 2012, 7, 699-712.
(2) Kim, C. H.; Kymissis, I. Graphene-Organic Hybrid Electronics. J. Mater. Chem. C 2017, 5, 4598-4613.
(3) Jariwala, D.; Howell, S. L.; Chen, K. S.; Kang, J. M.; Sangwan, V. K.; Filippone, S. A.; Turrisi, R.; Marks, T. J.; Lauhon, L. J.; Hersam, M. C. Hybrid, Gate-Tunable, Van Der Waals P-N Heterojunctions from Pentacene and MoS2. Nano Letters 2016, 16, 497-503.
(4) Jariwala, D.; Davoyan, A. R.; Wong, J.; Atwater, H. A. Van Der Waals Materials for Atomically-Thin Photovoltaics: Promise and Outlook. Acs Photonics 2017, 4, 2962-2970.
(5) Shen, W.; Yu, Y. Q.; Shu, J. N.; Cui, H. A Graphene-Based Composite Material Noncovalently Functionalized with a Chemiluminescence Reagent: Synthesis and Intrinsic Chemiluminescence Activity. Chem. Commun. 2012, 48, 2894-2896.
(6) Yin, P. T.; Shah, S.; Chhowalla, M.; Lee, K. B. Design, Synthesis, and Characterization of Graphene-Nanoparticle Hybrid Materials for Bioapplications. Chem. Rev. 2015, 115, 2483-2531.
(7) Mann, J. A.; Dichtel, W. R. Noncovalent Functionalization of Graphene by Molecular and Polymeric Adsorbates. J. Phys. Chem. Lett. 2013, 4, 2649-2657.
(8) MacLeod, J. M.; Rosei, F. Molecular Self-Assembly on Graphene. Small 2014, 10, 1038-1049.
(9) Bang, J. J.; Rupp, K. K.; Russell, S. R.; Choong, S. W.; Claridge, S. A. Sitting Phases of Polymerizable Amphiphiles for Controlled Functionalization of Layered Materials. J. Am. Chem. Soc. 2016, 138, 4448-4457.
(10) Villarreal, T. A.; Russell, S. R.; Bang, J. J.; Patterson, J. K.; Claridge, S. A. Modulating Wettability of Layered Materials by Controlling Ligand Polar Headgroup Dynamics. J. Am. Chem. Soc. 2017, 139, 11973-11979.
(11) Choong, S. W.; Russell, S. R.; Bang, J. J.; Patterson, J. K.; Claridge, S. A. Sitting Phase Monolayers of Polymerizable Phospholipids Create Dimensional, Molecular-Scale Wetting Control for Scalable Solution Based Patterning of Layered Materials. ACS Appl. Mater Interfaces 2017, 9, 19326-19334.
(12) Davis, T. C.; Russell, S. R.; Claridge, S. A. Edge-on Adsorption of Multi-Chain Functional Alkanes Stabilizes Noncovalent Monolayers on MoS₂. Chem. Commun. 2018, 54, 11709-11712.
(13) Ryder, C. R.; Wood, J. D.; Wells, S. A.; Hersam, M. C. Chemically Tailoring Semiconducting Two-Dimensional Transition Metal Dichalcogenides and Black Phosphorus. ACS Nano 2016, 10, 3900-3917.
(14) Stergiou, A.; Tagmatarchis, N. Molecular Functionalization of Two-Dimensional MoS2 Nanosheets. Chem. Eur J. 2018, 24, 18246-18257.
(15) Abellan, G.; Lloret, V.; Mundloch, U.; Marcia, M.; Neiss, C.; Gorling, A.; Varela, M.; Hauke, F.; Hirsch, A. Noncovalent Functionalization of Black Phosphorus. Angew. Chem. Int. Ed. 2016, 55, 14557-14562.
(16) Rabe, J. P.; Buchholz, S. Commensurability and Mobility in Two-Dimensional Molecular Patterns on Graphite. Science 1991, 253, 424-427.
(17) Mali, K. S.; Pearce, N.; De Feyter, S.; Champness, N. R. Frontiers of Supramolecular Chemistry at Solid Surfaces. Chem. Soc. Rev. 2017, 46, 2520-2542.
(18) Cai, B.; Zhang, S. L.; Yan, Z.; Zeng, H. B. Noncovalent Molecular Doping of Two-Dimensional Materials. ChemNanoMat 2015, 1, 542-557.
(19) Hoeben, F. J. M.; Jonkheijm, P.; Meijer, E. W.; Schenning, A. About Supramolecular Assemblies of Pi-Conjugated Systems. Chem. Rev. 2005, 105, 1491-1546.
(20) Georgakilas, V.; Tiwari, J. N.; Kemp, K. C.; Perman, J. A.; Bourlinos, A. B.; Kim, K. S.; Zboril, R. Noncovalent Functionalization of Graphene and Graphene Oxide for Energy Materials, Biosensing, Catalytic, and Biomedical Applications. Chem. Rev. 2016, 116, 5464-5519.
(21) Toth, P. S.; Velicky, M.; Ramasse, Q. M.; Kepaptsoglou, D. M.; Dryfe, R. A. W. Symmetric and Asymmetric Decoration of Graphene: Bimetal-Graphene Sandwiches. Adv. Funct. Mater 2015, 25, 2899-2909.
(22) Yang, Y.; Zimmt, M. B. Shape Amphiphiles in 2-D: Assembly of 1-D Stripes and Control of Their Surface Density. J. Phys. Chem. B 2015, 119, 7740-7748.
(23) He, J.; Myerson, K. J.; Zimmt, M. B. Zipping and Unzipping Monolayers: Switchable Monolayer Oligomerization and Adhesion Via Thiol-Disulfide Interconversion. Chem. Commun. 2018, 54, 3636-3639.
(24) Grim, P. C. M.; De Feyter, S.; Gesquiere, A.; Vanoppen, P.; Rucker, M.; Valiyaveettil, S.; Moessner, G.; Mullen, K.; De Schryver, F. C. Submolecularly Resolved Polymerization of Diacetylene Molecules on the Graphite Surface Observed with Scanning Tunneling Microscopy. Angew. Chem. Int. Ed. 1997, 36, 2601-2603.
(25) Lee, S. L.; Yuan, Z. Y.; Chen, L.; Mali, K. S.; Mullen, K.; De Feyter, S. Forced to Align: Flow-Induced Long-Range Alignment of Hierarchical Molecular Assemblies from 2D to 3D. J. Am. Chem. Soc. 2014, 136, 4117-4120.
(26) Lee, S. L.; Yuan, Z. Y.; Chen, L.; Mali, K. S.; Muellen, K.; De Feyter, S. Flow-Assisted 2D Polymorph Selection: Stabilizing Metastable Monolayers at the Liquid-Solid Interface. J. Am. Chem. Soc. 2014, 136, 7595-7598.
(27) Lee, S. L.; Chi, C. Y. J.; Huang, M. J.; Chen, C. H.; Li, C. W.; Pati, K.; Liu, R. S. Shear-Induced Long-Range Uniaxial Assembly of Polyaromatic Monolayers at Molecular Resolution. J. Am. Chem. Soc. 2008, 130, 10454-10455.
(28) Davis, T. C.; Bang, J. J.; Brooks, J. T.; McMillan, D. G.; Claridge, S. A. Hierarchically Patterned Noncovalent Functionalization of 2D Materials by Controlled Langmuir-Schaefer Conversion. Langmuir 2018, 34, 1353-1362.
(29) Okawa, Y.; Mandal, S. K.; Hu, C. P.; Tateyama, Y.; Goedecker, S.; Tsukamoto, S.; Hasegawa, T.; Gimzewski, J. K.; Aono, M. Chemical Wiring and Soldering toward All-Molecule Electronic Circuitry. J. Am. Chem. Soc. 2011, 133, 8227-8233.
(30) Chen, X. D.; Lenhert, S.; Hirtz, M.; Lu, N.; Fuchs, H.; Chi, L. F. Langmuir-Blodgett Patterning: A Bottom-up Way to Build Mesostructures over Large Areas. Acc. Chem. Res. 2007, 40, 393-401.
(31) Zasadzinski, J. A.; Viswanathan, R.; Madsen, L.; Garnaes, J.; Schwartz, D. K. Langmuir-Blodgett Films. Science 1994, 263, 1726-1733.
(32) Hayes, T. R.; Bang, J. J.; Davis, T. C.; Peterson, C. F.; McMillan, D. G.; Claridge, S. A. Multimicrometer Noncovalent Monolayer Domains on Layered Materials through Thermally Controlled Langmuir-Schaefer Conversion for Noncovalent 2D Functionalization. ACS Appl. Mater Interf. 2017, 9, 36409-36416.
(33) Blodgett, K. B. Monomolecular Films of Fatty Acids on Glass. J. Am. Chem. Soc. 1934, 56, 495-495.
(34) Blodgett, K. B.; Langmuir, I. Built-up Films of Barium Stearate and Their Optical Properties. Phys. Rev. 1937, 51, 0964-0982.
(35) Kurniawan, J.; Ventrici de Souza, J. F.; Dang, A. T.; Liu, G.-y.; Kuhl, T. L. Preparation and Characterization of Solid-Supported Lipid Bilayers Formed by Langmuir-Blodgett Deposition: A Tutorial. Langmuir 2018, 34, 15622-15639.
(36) Langmuir, I.; Schaefer, V. J. Activities of Urease and Pepsin Monolayers. J. Am. Chem. Soc. 1938, 60, 1351-1360.
(37) Claridge, S. A. Standing, Lying, and Sitting: Translating Building Principles of the Cell Membrane to Synthetic 2D Material Interfaces. Chem. Commun. 2018, 54, 6681-6691.
(38) Zhang, G. M.; Kuwahara, Y.; Wu, J. W.; Horie, Y.; Matsunaga, T.; Saito, A.; Aono, M. Scanning Tunneling Microscopy Observation of Langmuir-Blodgett Diacetylene Compound Films Deposited by Schaefer's Method. Jpn. J. Appl. Phys., Part 1 2002, 41, 2187-2188.
(39) Okawa, Y.; Takajo, D.; Tsukamoto, S.; Hasegawa, T.; Aono, M. Atomic Force Microscopy and Theoretical Investigation of the Lifted-up Conformation of Polydiacetylene on a Graphite Substrate. Soft Matter 2008, 4, 1041-1047.
(40) Giridharagopal, R.; Kelly, K. F. STM-Induced Desorption of Polydiacetylene Nanowires and Reordering Via Molecular Cascades. J. Phys. Chem. C 2007, 111, 6161-6166.
(41) Zhavnerko, G.; Marletta, G. Developing Langmuir-Blodgett Strategies Towards Practical Devices. Mater Sci. Eng. B-Adv. Funct. Solid-State Mater 2010, 169, 43-48.
(42) Li, X.; Gilchrist, J. F. Large-Area Nanoparticle Films by Continuous Automated Langmuir-Blodgett Assembly and Deposition. Langmuir 2016, 32, 1220-1226.
(43) Parchine, M.; McGrath, J.; Bardosova, M.; Pemble, M. E. Large Area 2D and 3D Colloidal Photonic Crystals Fabricated by a Roll-to-Roll Langmuir-Blodgett Method. Langmuir 2016, 32, 5862-5869.
(44) Parchine, M.; Kohoutek, T.; Bardosova, M.; Pemble, M. E. Large Area Colloidal Photonic Crystals for Light Trapping in Flexible Organic Photovoltaic Modules Applied Using a Roll-to-Roll Langmuir-Blodgett Method. Sol. Energy Mater Sol. Cells 2018, 185, 158-165.
(45) Porter, A. G.; Ouyang, T.; Hayes, T. R.; Biechele-Speziale, J.; Russell, S. R.; Claridge, S. A. 1-nm-Wide Hydrated Dipole Arrays Regulate AuNW Assembly on Striped Monolayers in Nonpolar Solvent. Chem 2019, 5, 2264-2275.

We claim:

1. An apparatus for performing noncovalent functionalization of a 2D material substrate using Langmuir-Schaefer (LS) conversion comprising
a. a motor configured to turn a roller equipped with a thermal regulation mechanism;
b. a Langmuir trough for preparing a molecular monolayer or thin film comprising functional amphiphiles; and
c. said roller comprising a disk mounted on a translator that brings the disk in contact with said functional monolayer or thin film, and to the periphery of said disk is mounted a 2D material substrate.

2. The apparatus according to claim 1, wherein said motor is a stepper motor fit for fine speed control of said roller's rotation while the disk is in contact with the functional monolayer or thin film during transferring process.

3. The apparatus according to claim 1, wherein said 2D material substrate comprises graphene, highly oriented pyrolytic graphite (HOPG), or a layered material of MoS₂ or WS₂.

4. The apparatus according to claim 1, wherein said 2D material substrate is mounted to the disk through an adhesive.

5. The apparatus according to claim 4, wherein said adhesive is stable toward use at an elevated temperature.

6. The apparatus according to claim 1, wherein said apparatus is configured for continuous roll-to-roll operation.

7. The apparatus according to claim 1, wherein said molecular monolayer or thin film is capable of being transferred to create a surface conferring controllable wetting characteristics or chemical functional patterns on the 2D material substrate.

8. The apparatus according to claim 1, wherein said functional Langmuir film is designed to be photopolymerized following assembly on the 2D material substrate in order to stabilize the molecular monolayer or thin film following transfer.

9. The apparatus according to claim 1, wherein said functional Langmuir film comprises a polymerizable amphiphile comprising both hydrophobic and hydrophilic constituents.

10. The apparatus according to claim 9, wherein the transfer is carried out under conditions that lead the molecules of said amphiphile transferred to the 2D material substrate to be converted into a striped phase on the 2D material substrate, wherein said hydrophilic and hydrophobic constituents of the amphiphile are displayed in a regular manner at the interface, creating functional stripes with a pitch regulated by the length of the molecules of said amphiphile.

11. A process for performing noncovalent functionalization of a 2D material substrate using Langmuir-Schaefer (LS) conversion comprising the steps of
a. preparing a molecular monolayer or thin film comprising functional amphiphiles, using a Langmuir trough;
b. preparing a 2D material substrate mounted on the periphery of a thermally regulated disk operable by a motor; and
c. transferring molecules from the monolayer or thin film on the Langmuir trough onto said 2D material substrate by rotation of said thermally regulated disk.

12. The process of claim 11 further comprising a step of chemical processing and/or manipulation of said monolayer or thin film to create a multifunctional patterned surface.

13. The process of claim 12, wherein said monolayer or thin film is a polymerizable monolayer or thin film having a controllable wetting characteristics or pattern.

14. The process of claim 11 further comprising a step of polymerizing/curing/crosslinking of said functional molecular monolayer or thin film on said supporting 2D material substrate.

15. The process of claim 14, wherein said polymerizing/curing/crosslinking is carried out using the functional molecular monolayer or thin film of polymerizable amphiphiles.

16. The process of claim 15, wherein said polymerization of an amphiphile monolayer or thin film is performed by irradiating with an UV light.

17. The process of claim 15, wherein said polymerizable amphiphile is a polymerizable lipid.

18. The process of claim 15, wherein said polymerizable amphiphile is a single-chain or dual chain polymerizable lipid incorporating one or more functional groups such as carboxylic acids, amines, or phosphates.

19. The process of claim 18, wherein said polymerizable single-chain amphiphile is 10,12-pentacosadiynoic acid or an analog thereof.

20. The process of claim 18, wherein said dual-chain amphiphile is 1,2-bis(10,12-tricosadiynoyl)-sn-glycero-3-phosphocholine (diyne PC), 1,2-bis(10,12-tricosadiynoyl)-sn-glycero-3-phosphoethanolamine (diyne PE), or an analog thereof.

21. The process of claim 11, wherein said 2D material substrate is graphene, highly oriented pyrolytic graphite (HOPG), or a layered material of MoS₂ or WS₂.

22. A sub-nanometer-thick coating or functional surface on a 2D material substrate manufactured according to a process comprising the steps of
a. preparing a functional Langmuir film of a monolayer or thin film comprising functional amphiphiles, using a Langmuir trough;
b. preparing a 2D material substrate mounted on the periphery of a thermally regulated disk operable by a motor; and
c. transferring the monolayer or thin film onto said 2D material substrate by rotating said thermally regulated disk by said motor.

23. The sub-nanometer-thick coating or functional surface of claim 22, wherein said process further comprises a step of chemical processing and/or manipulation of said polymerizable monolayer or thin film to create a multifunctional patterned surface.

24. The sub-nanometer-thick coating or functional surface of claim 22, wherein said process further comprises a step of chemical processing and/or manipulation of said polymerizable monolayer or thin film before applying said transferring material.

25. The sub-nanometer-thick coating or surface of claim 22, wherein said 2D material substrate is graphene, highly oriented pyrolytic graphite (HOPG), or a layered material of MoS₂ or WS₂.
